(19) United States
(12) Patent Application Publication
(10) Pub. No.: US 2025/0155623 A1
(43) Pub. Date: May 15, 2025

(54) NANOSTRUCTURED BIREFRINGENT OPTICAL ELEMENTS AND MICROSCOPES WITH NANOSTRUCTURED BIREFRINGENT OPTICAL ELEMENTS

(71) Applicants: University of Southampton, Southampton (GB); The Marine Biological Laboratory, Woods Hole, MA (US)

(72) Inventors: Peter KAZANSKY, Southampton (GB); Michael SHRIBAK, Southampton (GB)

(73) Assignees: University of Southampton, Southampton (GB); The Marine Biological Laboratory, Woods Hole, MA (US)

(21) Appl. No.: 18/835,794

(22) PCT Filed: Feb. 2, 2023
(86) PCT No.: PCT/GB2023/050230

§ 371 Date: Aug. 5, 2024

Related U.S. Application Data
(60) Provisional application No. 63/306,523, filed on Feb. 4, 2022.

(51) Int. Cl. G02B 5/30; G02B 21/14

(52) U.S. Cl. CPC G02B 5/3083; G02B 21/14; G02B 2207/101

(57) ABSTRACT

A birefringent optical element for transforming an incident beam of light into two spatially separated output beams of light with orthogonal linear polarizations comprises: a transparent substrate with an input face for receiving the incident beam, an output face, and a uniform thickness between the input face and the output face, the substrate having a non-uniform birefringence in a plane parallel to the input face, the birefringence provided by a plurality of randomly positioned nanostructures within the substrate and configured to cause the incident beam to shear within the substrate into two output beams with orthogonal linear polarisations and wavefronts at an angle to one another so that the output beams leave the output face with a spatial separation along a shear direction parallel to the output face; wherein each nanostructure has an oblate spheroidal shape.

This invention was made with United States government support under grant number GM101701 awarded by the National Institutes of Health. The government has certain rights in the invention.

### BACKGROUND OF THE INVENTION

The present invention relates to nanostructured birefringent optical elements, and the use of such optical elements in differential interference contrast microscopes.

A Wollaston prism is an optical device or element that can be used to manipulate polarized light. Propagation through a Wollaston prism transforms an incident light beam into an output comprising two linearly polarized output light beams which have wavefronts at an angle to one another so that the two output beams are spatially separated with diverging propagation directions. A Wollaston prism is formed from two individual right-angled prisms or wedges of a birefringent material which are cemented together with their hypotenuse faces abutting, and with the optical axes of the two wedges orthogonal to one another. The refractive index differences provided by the orthogonal orientations of the optical axes causes the divergence of ordinary and extraordinary components of the propagating light beam, giving the two separate output beams. The angle of divergence depends upon the wedge angle. Uniaxial birefringent crystal materials such as quartz or calcite may be used for the wedges.

A related device is a Nomarski prism. This also comprises two prisms or wedges of birefringent material with orthogonal optical axes. However, in a Wollaston prism both optical axes are parallel to the input and output faces of the prism, while in a Nomarski prism the input wedge has its optical axis oriented at an angle to the input face. The effect of this is that the angled wavefronts of the two output beams cause the spatially separated output beams to converge to a focal point outside the prism, rather than to diverge.

The cutting and polishing of the wedges from bulk crystals, and subsequent cementing to create the prism can be complex and difficult, leading to a costly finished product.

An important application of Wollaston prisms and Nomarski prisms is in differential interference contrast (DIC) microscopes. This is a type of microscope that produces a monochromatic shadow-cast image of the optical path (refractive index) gradient in a transparent specimen, which enables observations such as of structure and motion in unstained living cells and isolated organelles. A more sophisticated version is the orientation-independent DIC microscope. In both microscope types, the imaging is achieved by passing a pair of spatially separated and orthogonally polarized light beams through the specimen being observed, the specimen introducing the required optical path difference between the two beams. Wollaston and/or Nomarski prisms are used to provide the two beams. A first prism is placed before the specimen, with an associated condensing lens to make the beams parallel for propagation through the specimen. An objective lens collects the beams after interaction with the specimen and converges them to a second prism where they are recombined into a single beam for observation.

Besides the cost of Wollaston and Nomarski prisms (which can be exacerbated by the requirement for a small wedge angle), a further difficulty is that prisms must be tailored to the specification of the microscope model or design for which they are intended, and cannot be exchanged between different microscopes. Also, a prism must be unmounted and cut into a particular shape to fit into a microscope. Microscope manufacturers do not provide suitable prisms with their microscopes, however. A typical delivery time of six months or more for newly-ordered prisms can therefore cause significant delays for new projects.

Accordingly, alternatives to Wollaston and Nomarski prisms are of interest.

### SUMMARY OF THE INVENTION

Aspects and embodiments are set out in the appended claims.

According to a first aspect of certain embodiments described herein, there is provided a birefringent optical element for transforming an incident beam of light into two spatially separated output beams of light with orthogonal linear polarizations, comprising: a transparent substrate with an input face for receiving the incident beam, an output face, and a uniform thickness between the input face and the output face, the substrate having a non-uniform birefringence in a plane parallel to the input face, the birefringence provided by a plurality of randomly positioned nanostructures within the substrate and configured to cause the incident beam to shear within the substrate into two output beams with orthogonal linear polarisations and wavefronts at an angle to one another so that the output beams leave the output face with a spatial separation along a shear direction parallel to the output face; wherein each nanostructure has an oblate spheroidal shape with an elliptical cross-section in a plane parallel to the input face, the orientation of the elliptical cross-section giving a slow axis orientation of birefringence and a size of the oblate spheroidal shape giving a retardance value of birefringence, the orientation and the size varying between the nanostructures to provide the non-uniform birefringence of the substrate.

According to a second aspect of certain embodiments described herein, there is provided an optical assembly for transforming an incident beam of light into two spatially separated output beams of light with orthogonal linear polarizations, comprising: a first birefringent optical element according to the first aspect; a second birefringent optical element according to the first aspect; and an optical rotator sandwiched between the first birefringent optical element and the second birefringent optical element.

According to a third aspect of certain embodiments described herein, there is provided a differential interference contrast microscope comprising one or both of: a birefringent optical element according to the first aspect, and arranged to shear an illuminating beam of light in the microscope into two spatially separated beams of light with orthogonal linear polarizations for illuminating a specimen placed in the microscope; and a birefringent optical element according to the first aspect, and arranged to receive two spatially separated beams of light with orthogonal linear polarizations from the specimen by transmission or reflection, and converge the two spatially separated beams of light into a single output beam of light for observation or detection.

According to a fourth aspect of certain embodiments described herein, there is provided an orientation-independent differential interference contrast microscope comprising one or both of: an optical assembly according to the second aspect, and arranged to shear an illuminating beam of light in the microscope into two spatially separated beams of light with orthogonal linear polarizations for illuminating a specimen placed in the microscope; and an optical assembly according to the second aspect, and arranged to receive two spatially separated beams of light with orthogonal linear polarizations from the specimen by transmission or reflection, and converge the two spatially separated beams of light into a single output beam of light for observation or detection.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, devices and apparatus may be provided in accordance with approaches described herein which includes any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIG. 1 shows a schematic representation of a first example of a differential interference contrast microscope in which nanostructured birefringent optical elements according to examples and embodiments of the invention may be used;

FIG. 2 shows a schematic representation of a second example of a differential interference contrast microscope in which nanostructured birefringent optical elements according to examples and embodiments of the invention may be used;

FIG. 3 shows a schematic representation of the structure and operation of a beam shearing prism such as is conventionally used in differential interference contrast microscopes of the type shown in FIGS. 1 and 2;

FIG. 4 shows a schematic plan view of a first example of a nanostructured birefringent optical element according to an aspect of the present invention, on which a graphical representation of a proposed birefringence profile is shown;

FIG. 5 shows a photograph of a nanostructured birefringent optical element fabricated to include the proposed birefringence profile of the FIG. 4 example (taken using a polychromatic polarization microscope and a color CCD camera);

FIG. 6A shows an image of a specimen taken using a differential interference contrast microscope when fitted with conventional beam shearing prisms;

FIG. 6B shows an image of the same specimen shown in FIG. 6A taken using the same differential interference contrast microscope when fitted with the nanostructured birefringent optical element shown in FIG. 5;

FIG. 7 shows a schematic plan view of a second example of a nanostructured birefringent optical element according to an aspect of the present invention, on which a graphical representation of an alternative proposed birefringence profile is shown;

FIG. 8 shows a photograph of a nanostructured birefringent optical element fabricated to include the proposed birefringence profile of the FIG. 7 example (taken using a polychromatic polarization microscope and a color CCD camera);

FIG. 9A shows an image of a specimen taken using a differential interference contrast microscope when fitted with conventional beam shearing prisms;

FIG. 9B shows an image of the same specimen shown in FIG. 9A taken using the same differential interference contrast microscope when fitted with the nanostructured birefringent optical element shown in FIG. 8;

FIG. 10 shows a schematic representation of a first example of an orientation-independent differential interference contrast microscope in which nanostructured birefringent optical elements according to examples and embodiments of the invention are used;

FIG. 11 shows a schematic representation of a second example of an orientation-independent differential interference contrast microscope in which nanostructured birefringent optical elements according to examples and embodiments of the invention are used; and

FIG. 12 shows a simplified schematic representation of an individual oblate anisotropic nanopore or nanostructure within a substrate, by which birefringence in nanostructured optical elements according to the present invention is provided.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of devices and apparatus discussed herein which are not described in detail may be implemented in accordance with any conventional techniques for implementing such aspects and features.

A differential interference contrast (DIC) microscope is a beam-shearing interference system in which a reference or illuminating light beam is sheared by a small amount (generally by somewhat less than the diameter of an Airy disk) before being transmitted through a specimen under observation. By “sheared” it is meant that the beam is divided into two spatially separated beams, which in this case also have orthogonal linear polarization states owing to the conventional use of Wollaston or Nomarski prisms to produce the shear. By illuminating the specimen with the sheared beams, the microscope produces a monochromatic shadow-cast image that displays the gradient of optical paths. Those regions of the specimen where the optical paths increase along a reference direction appear brighter (or darker), while regions where the path differences decrease appear in reverse contrast. As the gradient of the optical path grows steeper, image contrast is significantly increased. Another important feature of the DIC technique is that it produces effective optical sectioning of the specimen. This is particularly marked when high numerical aperture objective lenses are used together with high numerical aperture condenser illumination.

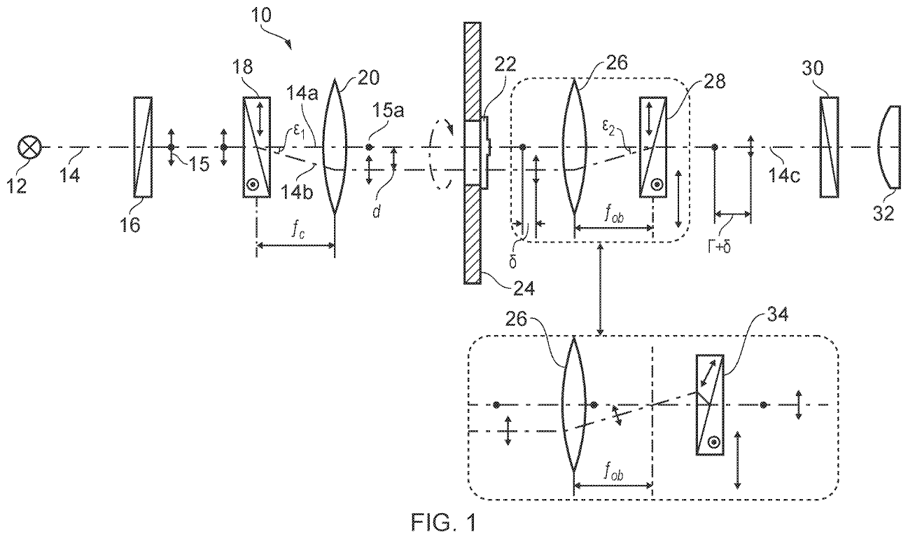

FIG. 1 shows a schematic representation of an example DIC microscope according to a known configuration, in which the illuminating light is transmitted through the specimen for detection or observation. The DIC microscope 10 comprises a light source 12 for emitting a monochromatic plane wave reference light beam 14 by which a specimen can be illuminated. The light beam 14 passes through a polariser 16 with a 45° azimuth in order to set the polarisation state of the light beam 14 into ordinary and extraordinary components 15 at a proper orientation. The light beam 14 is then incident on an input face of a first Wollaston prism 18 arranged with its orthogonal optical axes parallel to the ordinary and extraordinary components of the light beam 14; hence the Wollaston prism 18 has a 0° azimuth (the angular orientation in a plane perpendicular to the optical propagation direction). The Wollaston prism 18 acts to split or shear the incident beam 14 into two spatially separated plane wave light beams 14a, 14b with orthogonal linear polarisations 15a. The linearly polarised light beams 14a, 14b leave the output face of the Wollaston prism 18 with divergent propagation directions separated by a splitting or shearing angle $1, being a property of the Wollaston prism 18, the separation being along a shear direction which is parallel to the output face of the Wollaston prism 18. The diverging linearly polarised beams 14a, 14b propagate to a condenser lens 20 placed at its focal distance fc from the Wollaston prism 18 in order to reorient the propagation directions and make the linearly polarised beams 14a, 14b parallel to one another, spaced apart along the shear direction by a shear amount d. The linearly polarised beams 14a, 14b are transmitted through a specimen 22 mounted on a rotatable stage 24 that allows its azimuth to be altered; the transmission through the material of the specimen introduces an optical path difference δ between the linearly polarised beams 14a, 14b. The beams 14a, 14b are collected by an objective lens 26 which converges their propagation directions at an angle ε2 which is selected to match the shearing or splitting angle of a second Wollaston prism 28 (again at 0° azimuth) placed at a distance f_{ob}, being the focal distance of the objective lens 26, behind the objective lens 26. The second Wollaston prism 28 receives the converging spatially separated linearly polarised beams 14a, 14b and makes them spatially coincident to output a single output light beam 14c, in which is preserved the optical path difference δ introduced by the specimen 22, supplemented by an optical path difference bias Γ introduced by the second Wollaston prism 28 to give a total optical path difference Γ+δ. The output beam 14 is passed through an optical analyser with a 45° azimuth, before reaching an ocular or an image sensor 32 for observation or detection of a shadow-cast image of the specimen 22, allowing visualization of phase non-uniformity of the specimen 22.

The insert to FIG. 1 shows that the second Wollaston prism 28 may be replaced with a Nomarski prism 34 placed beyond the focal distance fob of the objective lens 26.

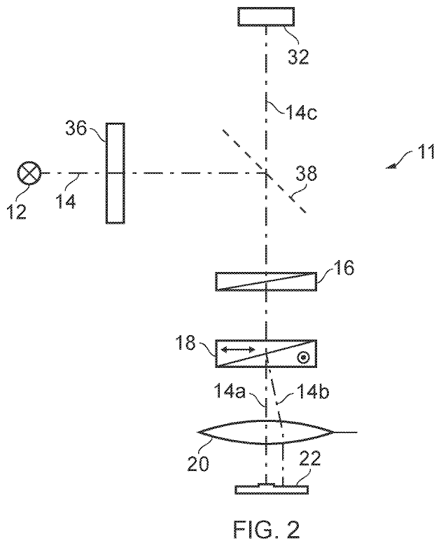

FIG. 2 shows a schematic representation of a second example of a DIC microscope according to a different known configuration in which the illuminating light beam is reflected from the specimen. A light source 12 emits an illuminating beam 14 as before, which passes through a filter 36 to reach a semi-transparent beam splitter 38. A fraction of the light beam 14 which is reflected by the beam splitter 38 is directed through a polariser 16 (at a 45° azimuth), a Wollaston prism 18 (at a 0° azimuth), and a condenser lens 20, as before, to provide the two spatially separated, parallel and orthogonally linearly polarised beams 14a, 14b, which reach the specimen 22. Rather than passing through the specimen 22 as in the FIG. 1 example, the light beams 14a, 14b are reflected from the specimen 22, and pass back through the lens 20, the Wollaston prism 18 and the polariser 16, so that these components act as the objective lens, the second Wollaston prism and the analyser of the FIG. 1 example, to produce the single output light beam 14c bearing the optical path difference information from the specimen 22. A fraction of the output light beam 14c passes through the beam splitter 38 (the filter 36 protecting the light source 12 from reflections from the beam splitter) for detection or observation at an image sensor or ocular 32. This reflected configuration gives a more compact microscope with fewer components than the transmission arrangement, but optical losses particularly at the beam splitter tend to reduce the optical intensity available for observation and detection, giving a dimmer image. As with the FIG. 1 example, the Wollaston prism may be replaced with a Nomarski prism.

The DIC microscopy enabled by DIC microscopes such as the examples of FIGS. 1 and 2 has some drawbacks, however. In order to achieve optimum imaging, it is necessary to ensure that the specimen is properly oriented relative to the optical system. Also, results are not directly quantitative. To address these limitations, an orientation-independent (OI-) DIC microscope has been developed [1, 2]. This allows the bias and shear directions to be switched rapidly, with no need to mechanically rotate or adjust the specimen or the prisms. Quantitative optical path length (phase) images of the specimen can be obtained with high fidelity and resolution. In particular, the individual Wollaston or Nomarski prisms are each replaced by a beam shearing assembly comprising a switchable 90° rotator sandwiched between two Wollaston or Nomarski prisms with their azimuths at 90° to one another. The rotator can be embodied by a liquid crystal device, for example.

As noted in the background section, a problem affecting DIC microscopes (of both the standard and the orientation-independent types) is the suitability and availability of appropriate Wollaston and Nomarski prisms. The prisms must be designed to be compatible with a specific microscope model, of which a number are commercially provided by different manufacturers. Hence, prisms designed for a microscope made by Olympus cannot be used with microscopes made by other manufacturers, such as Zeiss, Leica and Nikon. For compatibility, a prism must have the appropriate optical performance (particularly relating to the shear angle and the bias), as well as being unmounted and cut to the required shape for the microscope design. Microscope manufacturers may not provide appropriate prisms with their microscopes, however, so the user must obtain prisms separately, which is costly and can take several months. Factors contributing to a high cost for Wollaston and Nomarski prisms are the requirement for cutting and polishing the birefringent crystal material into the required wedge shape with the appropriate wedge angle (which is typically required to be small for DIC microscopy), and subsequent stage of cementing the prisms together in an optically suitable manner.

Accordingly, it is proposed to provide an alternative to Wollaston and Nomarski prisms, for use in DIC microscopes and for other applications, that offers the same optical functionality and performance in a simpler and less costly format, and also enables straightforward tailoring of the optical characteristics to meet the requirements of specific designs of microscope and other optical devices.

To achieve this, an optical element comprising a substrate in which birefringence is provided by nanostructures formed within the material of the substrate is proposed. Procedures for “writing” the nanostructures can be readily adjusted to create nanostructures that give a profile of varying birefringence across the substrate which mimics the beam-shearing function of Wollaston and Nomarski prisms and allows the shearing angle and bias to be set as required for any application. The optical element simulates the optical action of the prisms by similarly transforming (splitting, dividing or shearing) a single input beam into two output beams. The varying birefringence achieved by appropriate shaping of the nanostructures corresponds to the varying birefringence produced by the sloped boundary between the wedges in a prism. The substrate is a single piece of transparent optical material of uniform thickness, so the manufacturing precision required for cutting, polishing and cementing the wedges of Wollaston and Nomarski prisms is avoided. Also, the requirement for optical crystals which are naturally and inherently birefringent is negated, allowing costly crystalline materials such as quartz and calcite to be replaced with inexpensive silica-based glasses.

The nanostructures and techniques for forming the nanostructures will be described in more detail later. First, we look at the principles of operation of Wollaston and Nomarski prisms to understand the optical properties required to be duplicated by the proposed birefringent optical element, particularly with reference to use in a DIC microscope.

As explained above, FIG. 1 shows the shear amount or distance d by which the two orthogonally polarised beams created by the first Wollaston prism are separated in space. This distance is the spacing between the beams once they are parallelised by the condenser lens, so is dependent on both the shear angle between the two beams generated by the Wollaston prism, and the distance behind the Wollaston prism at which the beams meet the condenser lens, and over which the beams diverge along the shear angle thereby increasing their spatial separation. The shear distance is a critical parameter of a DIC microscope that determines its contrast, sensitivity, resolution and optical section depth.

FIG. 3 shows a schematic representation of a prism (Wollaston or Nomarski) and its operation in shearing an incident beam. An incident or input beam 14 is a monochromatic plane wave propagating along a propagation direction z, with a wavefront Ex and Ey of ordinary and extraordinary polarisation components lying in the x-y plane orthogonal to the propagation direction z. The beam 14 is incident on an input face 18a of a prism 18, where the input face lies in the x-y plane. The birefringent structure of the prism, formed from two wedges with orthogonal optical axes splits or shears the beam 14, according to known principles, into two separate linearly polarised beams with slightly different and diverging propagation directions (still generally in the z direction) which leave the output face 18b of the prism 18. A first output beam 14a has a plane wavefront Ex and a linear polarisation along the x direction, and a second output beam 14b has a plane wavefront Ey and an orthogonal linear polarisation along the y direction. The direction of shear, and hence the shear plane in which both beams 14a, 14b lie, is parallel to the x-axis in this example. The shear direction is also parallel to the output face while the shear plane is orthogonal to the output face. The propagation directions of the output beams 14a, 14b are separated by a shear angle ε (which depends on the optical properties and structure of the prism 18). Consequently, the wavefronts Ex and Ey lie at the same angle ε to one another, and have an optical path difference along the propagation direction z. As can be seen from the geometry of FIG. 3, the shear angle ε (in radians) is equal to the derivative of the optical path difference A (alternatively, the bias or retardance of the prism 18) with respect to the coordinate x (the shear direction), so that ¿=dΔ/dx.

In a DIC microscope, the shear amount or shear distance d is then set by passing the diverging beams through a condenser lens (see FIG. 1). If the lens has a focal distance f, the shear distance d is given by d=fε=ε·Lₜ/M, where M is the lens magnification. Lₜ is a standardized reference focal length for tube lenses for an infinity-focused objective lens, as adopted by several microscope manufacturers. For example, Olympus uses a reference focal length of 180 mm, Zeiss uses a reference focal length of 164.5 mm and Nikon and Leica use a reference focal length of 200 mm.

In order to substitute a particular conventional Wollaston or Nomarski prism with the proposed birefringent optical element, it is necessary to determine the shear angle of a prism in order to replicate this property in the optical element. The derivative of retardance with respect to the coordinate along the shear direction has been measured for a number of DIC microscope prisms in order to yield the shear angle in accordance with the geometry in FIG. 3 [3]. As examples, Olympus prism U-DIC40HR has a retardance derivative of 15 nm/mm with corresponding shear angle 15 μrad, and Olympus prism U-DIC20HR has a retardance derivative of 30 nm/mm with corresponding shear angle 30 μrad.

The birefringent optical elements proposed herein to replace Wollaston and Nomarski prisms are a simple planar substrate in which the birefringence is non-uniform and varies across the plane of the substrate, where in use the optical element is oriented with this plane orthogonal to the propagation direction of an incident optical plane wave. In terms of the DIC microscopes already described, the plane of the substrate therefore lies in the x-y plane, with the substrate having a thickness along the propagation direction z. The required shearing effect can be produced with a profile of varying birefringence. The profile is made up of the value of birefringence along the z-direction where different x-y locations exhibit different birefringence values (the variation is only present along one of these directions, giving the shear direction, with no variation along the other direction). Hence, for an incident beam with a finite beam cross-sectional area, different parts of the beam across its transverse profile (in the x-y plane) experience different birefringences. The birefringence at any location comprises two components: the retardance amount and the orientation (azimuth) of the slow optical axis direction (as is usual for birefringence). Various birefringence profiles can provide the required beam shearing, with the shear amount (angular separation of the two output beams) and the bias (optical path difference between the two output beams) which are achieved being selectable by tailoring the retardance and slow axis orientation across the profile. Two examples will be discussed in detail.

A first example has a birefringence profile made up of a variable retardance and a non-varying (fixed) slow axis direction. A second example has the converse arrangement, with a non-varying (fixed) retardance and a variable slow axis direction. More complex configurations in which both the retardance and the slow axis direction vary are also envisaged. However, the process for forming the nanostructures (described further below) can be simplified if only one component of the birefringence is variable, so this may be preferred. Also, in the examples, the birefringence profile is one-dimensional, such that in the plane of the substrate it varies along one direction (the x direction as described, corresponding to the shearing direction) and is constant along the other direction (the y direction as described). This corresponds with a beam shearing prism, owing to the geometry of the wedge boundary. However, it is also possible to vary the profile along both the x and y directions to achieve beam shearing.

### First Detailed Example

Assume that the substrate of the optical element has a birefringence profile defined within a field in the x-y plane with dimensions X mm by Y mm. A square field is practical given that the incident beam will typically have a circular cross-section. Hence, the birefringence profile exists in the area 0 mm<x<X mm, 0 mm<y<Y mm where X and Y are equal for a square field. A retardance derivative of a is required along the x direction (so the shear direction is along the x direction), to give an absolute retardance value Δ at any x position. Along the x direction, the variable retardance is chosen to have a zero value at the centre of the field (x=X/2), increasing to a maximum positive value at one edge of the field (x=X) and a maximum negative value at the opposite edge of the field (x=0), the maximum values being equal. In the half of the field with a positive retardance, the slow axis orientation q is fixed and chosen to be parallel to the x direction. In the other half of the field, with a negative retardance, the slow axis orientation is also fixed but orthogonal to the slow axis orientation in the positive half, so is parallel to the y direction. The orthogonal slow axis orientations may be reversed, however, or set at an angle to the x and y directions.

Accordingly, if we select the x direction as horizontal and the y direction as vertical, the birefringence profile (along the x direction) can be mathematically described as:

$$retardance Δ = α \cdot x - α X / 2$$

$$slow axis orientation φ = 90 ° , x < X / 2 ; φ = 0 ° , x > X / 2$$

Consider a specific example. The birefringence field is set to be 10 mm by 10 mm, so can be described by 0 mm<x<10 mm, 0 mm<y<10 mm. The retardance derivative α is selected to be 15 nm/mm, to correspond with the actual Olympus U-DIC40HR prism mentioned above. Hence, each half of the field in the x-direction has a width of 5 mm, giving a maximum retardance at the edges of the field of ±75 nm. The birefringence profile is therefore given by:

$$retardance Δ = α \cdot x - 75 nm$$

$$slow axis orientation φ = 90 ° , x < 5 mm ; φ = 0 ° , x > 5 mm$$

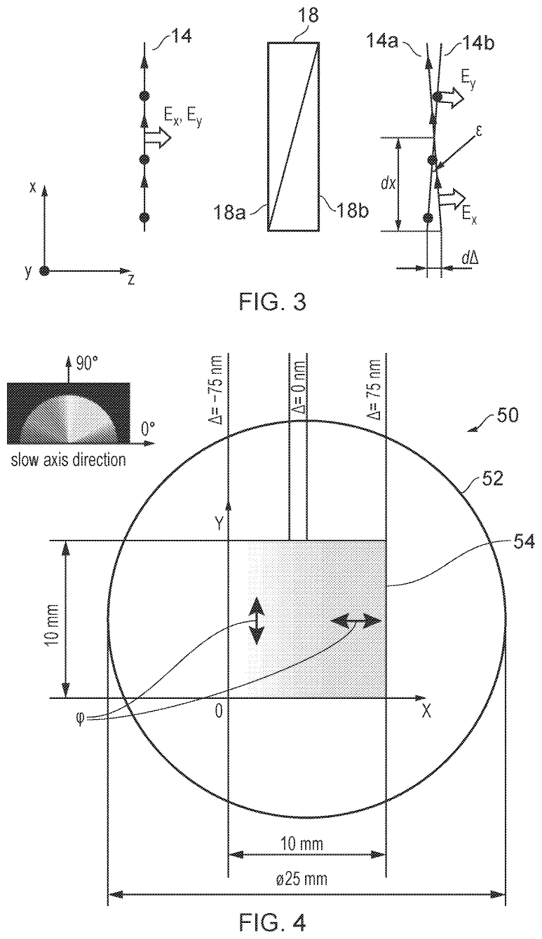

FIG. 4 shows a schematic plan view of an optical element having this birefringence profile. The optical element 50 comprises a circular substrate 52 formed from silica glass, having a planar form of constant thickness and diameter 25 mm. The birefringence profile is written across a square field 54 in the centre of the substrate, over an area of 10 mm by 10 mm. The orientation of the slow axis o in each half of the field are indicated by double-ended arrows; as described above, the orientation is fixed or constant within each half where the two halves lie either side of the centre line at x=5 mm. Vertical lines indicate where the value of the retardance Δ is 0 mm at x=5 mm, −75 nm at x=0 mm and +75 nm at x=10 mm. The variation of the retardance value along the x direction is indicated by shading where the saturation of the shading is proportional to the absolute size of the retardance (so maximum saturation is at the edges of the field 54). The absolute value of the retardance increases linearly with distance from the centre line, owing to the dependence of Δ on α·x indicated above. In other words, the retardance has a constant gradient. An optical element configured according to the first example is optically equivalent to a Wollaston prism.

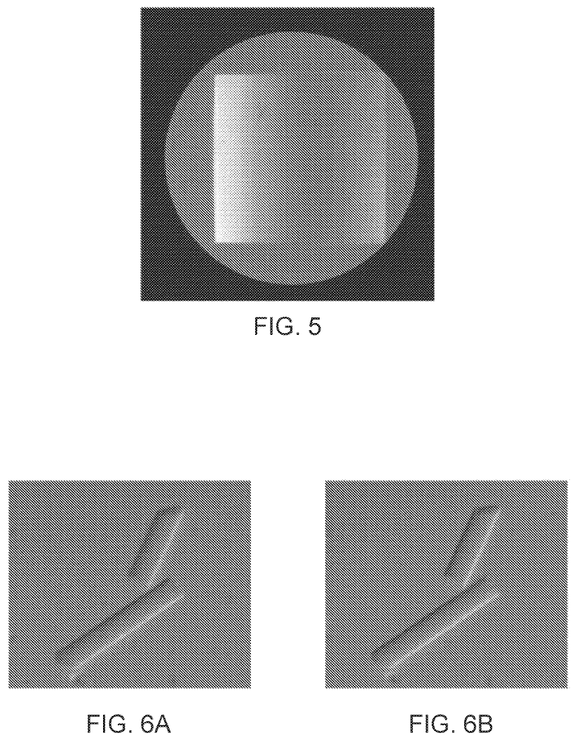

FIG. 5 shows a photograph of an experimental optical element fabricated according to this specification. The photograph was taken using a polychromatic polarization microscope and a color CCD camera (Lumenera Infinity 3-1C). As can be seen, the pattern of shading corresponds to the theoretical representation of the birefringence profile in FIG. 4, indicating that the optical element was successfully fabricated in accordance with the design.

In order to assess the performance of the experimental optical element of the first example it was used in a microscope configured for DIC microscopy to obtain images of a specimen, which were compared with images of the same specimen taken using the same microscope equipped with a conventional shearing prism. The microscope was a research microscope, Olympus BX61, equipped with a 40× objective lens, a high resolution DIC slider U-DICTHR, a bandpass filter 576/10 nm, and a monochromatic CCD camera, Lumenera Infinity 3-1M to record the images. In the illumination path (so, the prism position between the light source and the specimen-see FIG. 1) was placed either a conventional DIC shearing prism, being an Olympus U-DIC40HR, or the experimental optical element of the first example. The U-DIC40HR has a shear angle of 15 μrad arising from a retardance derivative of 15 nm/mm as mentioned above, and also as mentioned, the optical element of the first example was fabricated to have this same retardance derivative (and hence the same shear angle).

The specimen comprised short segments of glass rod, used as spacers in liquid crystal cells, embedded in Fisher Permount Mounting Medium (from Fisher Scientific Company LLC). This was selected as being optically similar to transparent filaments in a cell structure, a typical subject of observation via DIC microscopy. The refractive indices of the glass rods and the Permount at a wavelength of 546 nm were measured using a Jamin-Lebedeff microscope (from Zeiss), as being 1.554 and 1.524 respectively. A drop of the suspension was placed between a microscope slide and a coverslip, and the resulting specimen was placed on the rotatable stage of the microscope, as in FIG. 1.

FIG. 6A shows an image of the specimen recorded using the microscope fitted with the U-DIC40HR prism, and FIG. 6B shows an image of the specimen recorded using the microscope when fitted with the optical element of the first example. As can be seen, both images are crisp and have the same contrast. Accordingly, an optical element with a birefringent profile configured according to the first example can readily replace a conventional DIC microscope prism without any loss of image quality. Moreover, the flexibility in forming the birefringent nanostructure in the substrate of the optical element (discussed further below) offers potential for optical elements to exhibit an improved performance compared to conventional DIC prisms.

### Second Detailed Example

In this example, the birefringence profile of the birefringent field of the optical element has a non-varying (fixed) retardance and a variable slow axis orientation. Again, assume that the substrate of the optical element has a birefringence profile defined within a field in the x-y plane with dimensions X mm by Y mm, so that the profile is present in the area 0 mm<x<X mm, 0 mm<y<Y mm where X and Y are equal for a square field. In order to give a shear direction along with x direction, the slow axis orientation or azimuth φ is varied along the x direction. The variation is uniform in that the value of the slow axis azimuth has a constant gradient across the field; hence the value of the slow axis azimuth is proportional to the value of x. The retardance Δ is fixed at a constant value along the x direction, so there is the same amount of retardance at all x positions. In this example, a retardance value of half the wavelength λ of the intended incident light beam is selected; other values might be used, however.

Accordingly, if we select the x direction as horizontal and the y direction as vertical, the birefringence profile (along the x direction) can be mathematically described as:

$$retardance Δ = λ / 2$$

$$slow axis orientation φ = β \cdot x$$

(where β is the gradient magnitude of rotation of the slow axis).

This design gives an optical element in which the evolution of the propagating wavefront though the substrate follows the geometric phase principle.

Consider a specific example. The birefringence field is set to be 10 mm by 10 mm, so can be described by 0 mm<x<10 mm, 0 mm<y<10 mm. The slow axis gradient magnitude of rotation β is chosen to be 5.5°/mm. The wavelength λ is selected as 560 nm, so that the retardance Δ is half of this value, 280 nm.

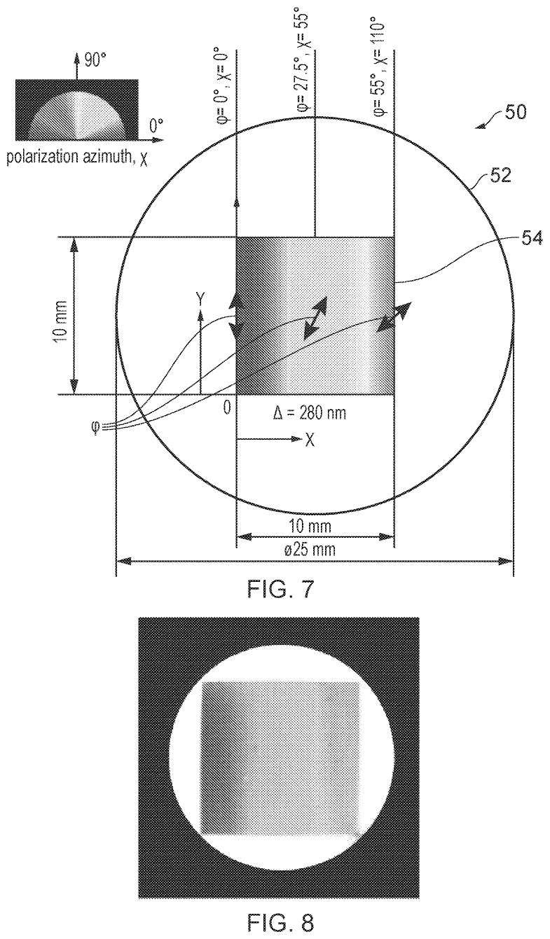

FIG. 7 shows a schematic plan view of an optical element having this birefringence profile. The optical element 50 again comprises a circular substrate 52 formed from silica glass, having a planar form of constant thickness and diameter 25 mm. The birefringence profile is written across a square field 54 in the centre of the substrate, over an area of 10 mm by 10 mm. The retardance Δ is fixed at 280 nm across the birefringence field. The varying orientation of the slow axis φ is indicated by double ended arrows. In accordance with the above relationship, indicating a constant gradient for the slow axis orientation, on the left edge of the field x=0 mm so φ=0°, at the centre of the field x=5 mm so φ=27.5°, and on the right edge of the field x=10 mm so φ=55°, with a smooth transition between these positions as the value of x increases. The shading of the field used in the Figure corresponds to the azimuth of the polarisation plane of the output beam. Since the retardance is set to be half the wavelength, the output polarisation plane is rotated by twice the angle of the slow axis azimuth. Hence, the output polarisation azimuth χ varies from 0° to 110° along the x direction, as indicated in the Figure.

FIG. 8 shows a photograph of an experimental optical element fabricated according to this specification. The photograph was taken using a polychromatic polarization microscope and a color CCD camera (Lumenera Infinity 3-1C). As can be seen, the pattern of shading corresponds to the theoretical representation of the birefringence profile in FIG. 7, indicating that the optical element was successfully fabricated in accordance with the design.

If an optical element with the birefringence profile is illuminated by a linearly polarised beam with a vertical polarisation, the azimuth χ of the polarisation plane of the output beam is given by χ=2βx (so, twice the slow axis azimuth as noted above). However, the rotation of the linear polarisation by the angle χ can be described as a phase shift between two orthogonal circular (left and right) eigenwaves ψ, so that ψ=2χ=4βx. Then, the derivative of the phase shift between the left and right circular eigenwaves is given by dψ/dx=4β. Accordingly, the optical path difference or retardance derivative ε can be described by ε=(λ/360° dψ/dx=λ(β/90°. (As an aside, it is mentioned that the optical element of the second example, which can be described as a geometric phase optical device, operates similarly to a Fresnel triprism, which is a further example of a prism with beam shearing capability, but uses a different principle of transformation of the beam polarisation).

Recall that the retardance derivative corresponds to the shear angle. In the present example, λ=560 nm and β=5.5°/mm, so the shear angle introduced between two orthogonal circularly polarised beams is 34 μrad (2 millidegree). This is similar to the shear angle of the Olympus DIC prism U-DIC20HR, which as already noted is 30 μrad. Hence, it is feasible to compare experimental optical element with the Olympus prism to assess its performance.

Accordingly, a similar experiment was performed as with the experimental optical element of the first example, by using the experimental optical element of the second example in a microscope configured for DIC microscopy to obtain images of a specimen, and comparing these with images of the same specimen taken using the same microscope equipped with a conventional shearing prism. The microscope was again an Olympus BX61 microscope, this time equipped with a 20× objective lens, a high resolution DIC slider U-DICTHR, a bandpass filter 576/10 nm, and a monochromatic CCD camera, Lumenera Infinity 3-1M to record the images. In the illumination path (so, the prism position between the light source and the specimen-see FIG. 1) was placed either a conventional DIC shearing prism, being in this case an Olympus U-DIC20HR (having a similar shear angle to the second example optical element, as noted), or the experimental optical element of the second example. The same specimen was used as in the experiments with the first example optical element.

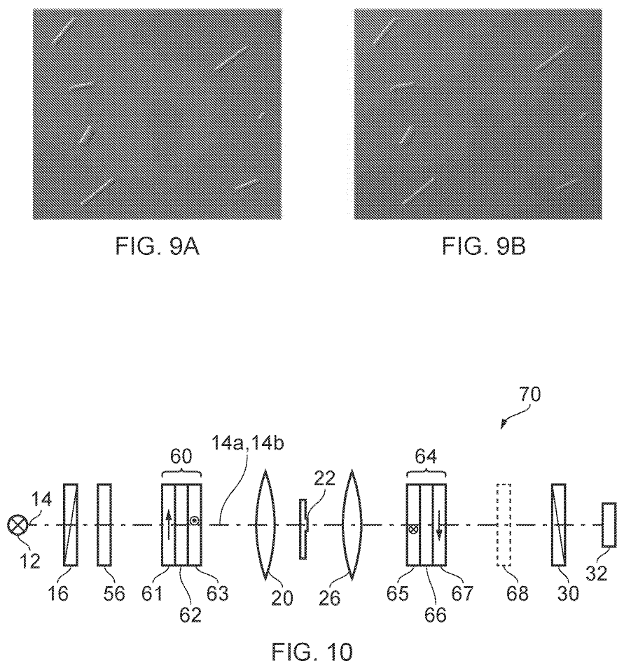

FIG. 9A shows an image of the specimen recorded using the microscope fitted with the U-DIC20HR prism, and FIG. 6B shows an image of the specimen recorded using the microscope when fitted with the optical element of the second example. Both images are good quality, but it may be perceived that the image obtained with the conventional prism has a more uniform field of view and a little better contrast. One reason for this is that the shear angle of the optical element (34 μrad) is a little higher than the shear angle of the Olympus prism (30 μrad) so the former is not a direct substitute for the latter, and will produce a different shear distance within the microscope for which other components of the microscope are not optimised. Also, further studies revealed a manufacturing defect in the optical element of the second example. However, it is anticipated that with a correctly matched shear angle (which can be achieved by modifying the parameters of the process for forming the birefringent nanostructures in the substrate) and no defects, the same image quality can be obtained. Accordingly, an optical element with a birefringent profile configured according to the second example can also readily replace a conventional DIC microscope prism without any loss of image quality.

Accordingly, DIC microscopes arranged as shown in the example of FIG. 1, or other similar arrangements, in which light is transmitted through the specimen, may be reconfigured by substituting the Wollaston or Nomarski prisms with birefringent optical elements as described herein. Both of the prisms may be substituted, or a single prism only (either the first prism before the specimen or the second prism after the specimen). If both prisms are substituted, the two optical elements may be the same or may be different. For example, one may be according to the first detailed example and one may be according to the second detailed example, or both may be according to the same detailed example but with different values of optical axis azimuth or retardance in the birefringence profile (as appropriate for functionality with other components of the microscope). Similarly, the single Wollaston or Nomarski prism in the reflection-type of DIC microscope in the FIG. 2 example may be substituted with a birefringent optical element as described herein, for example according to the first detailed example or the second detailed example.

Additionally, birefringent optical elements as described herein may be used in orientation-independent (OI-) DIC microscopes [1, 2]. These have a largely similar structure as the non-Ol versions of DIC microscopes, but an important difference for enabling the orientation independence is that the or each beam shearing prism is replaced with a beam shearing assembly that comprises a pair of beam shearing prisms (Wollaston or Nomarski) with their optical axes arranged orthogonally, and a 90° optical rotator sandwiched between them. The optical rotator may be a liquid crystal device, for example. These prisms may be replaced with birefringent optical elements as described herein (according to the first or second detailed examples, for instance), to provide a beam shearing assembly comprising a pair of birefringent optical elements with a 90° optical rotator sandwiched between them.

FIG. 10 shows a schematic representation of an example of an OI-DIC microscope 70 that uses transmission of the illuminating beam through a specimen, similarly to the FIG. 1 example, in which birefringent optical elements are included in place of conventional beam-shearing prisms. Components common with the FIGS. 1 and 2 examples are labelled with the same reference numerals for ease of comparison and explanation. A light source 12 emits the illuminating beam 14 which passes through a 45° polarizer 16, and a phase shifter 56 at 0° orientation. Then, the beam reaches a first beam shearing assembly 60 which comprises a first birefringent optical element 61 with its optical axis at a 0° azimuth, a second birefringent optical element 63 with its optical axis orthogonal to the first birefringent optical element 61, so at a 90° azimuth, with a 90° optical rotator 62 sandwiched between them. The first beam shearing assembly shears the input illuminating beam into the required pair of orthogonally polarised beams (14a, 14b) diverging at a shear angle (not shown, for simplicity). The two beams 14a, 14b pass through a condenser lens 20 that parallelises the beams spaced by the shear distance, as before, and then are transmitted through the specimen 22 to acquire the path difference pattern to be observed. An objective lens 26 collects the beams 14a, 14b and converges them to a second beam shearing assembly 64. This also comprises an optical rotator 66 sandwiched between a first birefringent optical element 65 and a second birefringent optical element 67 with its optical axis orthogonal to that of the first optical element 65. However, the second beam shearing assembly 64 is rotated by 180° with respect to the first beam shearing assembly 60, so that the optical axes of the first birefringent optical element 65 and the second birefringent optical element 67 are respectively at 270° and 180° azimuths. The second beam shearing assembly 64 brings the beams into an overlapping common alignment, as before, to provide an output beam 14c for the microscope that carries the path difference information induced by the specimen 22. The output beam 14c passes through a displacement compensator 68 and an optical analyser at −45° to reach an image sensor or other optical detector 32 for detection/observation.

FIG. 11 shows a schematic representation of an example of an OI-DIC microscope 71 that uses reflection of the illuminating beam at a specimen, similarly to the FIG. 2 example, in which birefringent optical elements are included in place of a conventional beam-shearing prism. Components common with the FIGS. 1, 2 and 10 examples are labelled with the same reference numerals for ease of comparison and explanation. A light source 12 emits the illuminating beam 14 which passes through a 45° polariser 16 and a phase shifter 56 at 0° (as in the FIG. 10 arrangement) before reaching a beam splitter 38 (as in the FIG. 2 arrangement) which directs a part of the beam 14 towards a specimen. The beam first passes through a displacement compensator 68 before reaching a beam shearing assembly 60 which in common with the first beam shearing assembly 60 in the FIG. 10 arrangement comprises a first birefringent optical element 61 with its optical axis at a 0° azimuth, a second birefringent optical element 63 with its optical axis orthogonal to the first birefringent optical element 61, so at a 90° azimuth, with a 90° optical rotator 62 sandwiched between them. The beam shearing element 60 produces the two spatially separated beams 14a, 14b required for DIC microscopy, as before, which are parallelised by a condenser lens 20 before reaching the specimen 22. Here the beams 14a, 14b are reflected, and transmitted back through the condenser lens 20 and the beam shearing assembly 60 to remove the spatial separation and provide the single output beam 14c, then the displacement compensator 68 to reach the beam splitter 38, which transmits a part of the output beam 14c to an optical analyser 30 at −45° and finally to an image sensor 32 (similarly as described for the FIG. 2 example).

Hence, birefringent optical elements as proposed herein can be successfully used in both orientation-independent and non-orientation independent DIC microscopes. They are expected to be less expensive than conventional beam-shearing prisms, and owing to the fabrication methodology with is described further below, can be readily customised on an individual basis for each particular model or configuration of microscope (including commercially available DIC microscopes for which it is currently costly to obtain suitable prisms). Such customised optical elements can be more precise, can be configured to compensate for manufacturing or alignment errors in a microscope, and can provide better image contrast. Furthermore, the optical elements exhibit a negative birefringence with a maximum retardance that may be as low as about 200 nm. This is in contrast with conventional quartz beam-shearing prisms that have a positive birefringence and a much larger retardance of about 5000 nm. The negative birefringence and the smaller retardance amount will enable an increase in the field of view of DIC microscopes.

The birefringence of the optical elements described herein is provided by a nanostructure created within the optical element. The nanostructure comprises a collection of nanopores in a periodic or random distribution in an optically transparent material, typically silica glass. The nanopores are nanometre-scale structural modifications or changes in the bulk material that alter its refractive index and provide a negative birefringence. Although not yet well-understood, the nanopores are considered to be voids within the bulk material. The nanopores have a shape and orientation which confers the birefringent properties to the bulk material. They are created or “written” by the action of ultrashort (femtosecond) pulses of focused laser light directed into the substrate. The optical characteristics of the pulses determine the shape and orientation of the nanopores. Hence, the birefringent properties can be tailored by modifying the pulse characteristics, enabling a birefringent profile that emulates the beam-shearing capabilities of a Wollaston or Nomarski prism to be formed within the substrate by appropriate control of the laser pulses as they are applied to the substrate.

The amount of optical energy delivered to the substrate (determined by factors including the power, duration and repetition rate of the laser pulses) determines a type of the nanostructure which is formed. The pulses can provide sufficient accumulated heat and lattice thermalisation to induce permanent material modification in the substrate. One type of nanostructure, referred to as type II [3], comprises nanogratings in which nanopores are self-organised into periodic distributions that act as optical gratings, providing an anisotropic refractive index pattern and hence birefringence. There is a strong dependence of the anisotropy on the polarisation of the laser pulses, so the induced birefringence can be tailored into a required profile.

A more useful type of nanostructure for present purposes can have a reduced optical propagation loss compared to type II structures and has been designated as type X [3]. Type X nanostructures can be written using a reduced density of applied optical pulses than is required to produce the self-assembled periodicity of type II nanostructures. They show a relatively low birefringence, around four times less than the birefringence of type II nanogratings, but by appropriate beam shaping of the laser pulses, the nanostructures can be written with a relatively long length in the intended optical propagation direction through the optical element. Lengths of the order of 50 μm or more, for example up to about 100 μm, can be written. This length of nanostructure, lying along the light propagation direction, compensates for the low birefringence, since the required parameter for birefringent operation is phase retardance, defined as the product of birefringence and optical path length. The retardance parameter can be readily varied by adjustment of the lens to control the nanopore length, and adjustment of laser energy and pulse quantity to control the density of nanopores and the aspect ratio and volume of the individual nanopores.

A type X birefringent structural modification comprises randomly distributed individual nanopores or nanostructures. However, nanostructural periodicity is not required to provide the desired birefringence, which instead depends on the orientation of the individual structures within the bulk material. Hence, the absence of self-assembly is not a barrier to the production of high quality optical elements. Also, the type X anisotropy is controlled by the polarisation of the laser writing beam. Each nanopore has an anisotropy defined by its shape, which is an oblate spheroid (ellipsoid) shape, or lenticular shape. As noted, the nanopores are randomly spaced apart within the substrate material, although lying generally within a layer at a constant depth behind the optical input surface of the optical element. The oblate spheroid shape of each nanopore is oriented with the plane of its circular cross section parallel to the optical propagation direction through the optical element and perpendicular to the input surface of the optical element. The elliptical or oval cross-section which is parallel to the input surface can be oriented with its major axis at any angle, where the major axis is formed perpendicular to the polarisation of the writing light beam. The minor axis is parallel to the polarisation of the writing light beam. Since the overall shape is lenticular, the extent of the nanostructure in the optical propagation direction, namely the length along the direction through the thickness of the optical element from the input surface to the output surface, may be the same as or similar to the major axis. The overall shape of the nanostructure is determined by the intensity distribution of the laser pulses near the focal point.

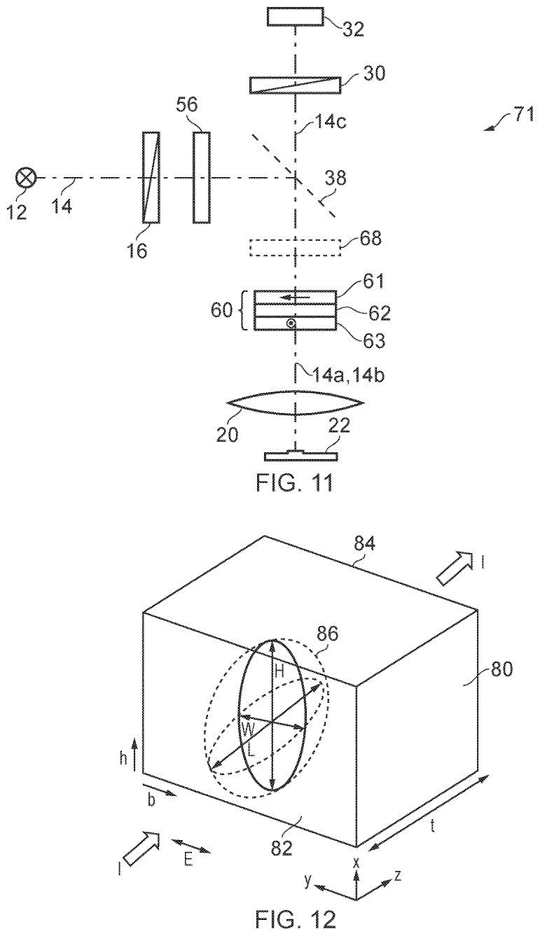

FIG. 12 shows a highly schematic and not-to-scale representation of an individual nanopore 86 within an optical element 80, which in the present case comprises a birefringent optical element with a birefringent profile that provide a beam shearing effect. For clarity, just a single nanopore is shown, but as described above, in reality the nanostructural modification comprises many such nanopores arranged within the material of the optical element substrate, randomly for a Type X modification and periodically for a Type II modification. The term “nanostructure” may refer to a single nanopore, or to a collection of nanopores (either a sub-group within a wider group, such as a nanograting, or all the nanopores present in an optical element). The optical element 80 has an input face 82 for receiving incident light, which propagates through the optical element along a propagation direction z which is parallel to the thickness t of the optical element and leaves through an output face 84 opposite to the input face 82. A focused writing light beam I of femtosecond pulses is incident on the input face 82 and has a polarisation E which in this example is linear and aligned parallel to the y direction, or breadth of the sample forming the optical element 10. In subsequent use of the fabricated optical element 80, an incident or input light beam I (such as the illuminating light beam in a DIC microscope) is modified or transformed into output light beam l′ (sheared into two parts in this instance, not shown) by the birefringence of the optical element 80 created by the writing process. The nanopore 86 has a length L substantially parallel to the thickness t of the optical element, which is typically not greater than 100 nm. The length L is perpendicular to the plane of the input face 12. The nanopore 86 has a cross-sectional shape in a plane parallel to the input face which has an oval, elliptical or oblate shape, with a major axis or height H and a smaller minor axis or width W orthogonal to the height. The major axis is larger than the minor axis. The width W has a size not larger than about 30 nm, typically. Owing to the oblate spheroidal shape of the nanopore 86, the length L and the height H may be substantially equal so that the cross-section of the nanopore 20 through the length L and height H may be roughly circular. In some cases there may be some small or more significant difference between the length L and height H, since the growth of the nanopore during the writing process along these two dimensions may evolve differently. For example, the length L may become greater than the height H. Typically, though, L and H will be at least similar to each other when compared to the width W, which is less than both. The input face 82 has a height dimension h and an orthogonal breadth direction b. The width W and height H of the nanostructure 20 lie at some angle to the height h and the breadth b; this sets the orientation of the nanopore 86 which is defined as lying along the height direction (major axis). Either of H and W can be parallel to either of h or b, or can be arranged at any angle between the parallel alignment. This orientation (direction of the major axis H) is the direction (azimuth) of the slow axis of the birefringence offered by the nanostructure comprising the nanopore. The orientation is set by the polarisation E of the writing light beam I, where W is parallel to E and H is perpendicular to E. Hence, rotation of the polarisation direction of the writing light beam controls the slow axis direction of the generated birefringence. The length L of the nanopore 20, being the dimension along the optical propagation direction, partly determines the total retardance available from the birefringence, and can be varied by controlling the amount of optical energy applied to form the nanopores. The contribution of the nanopore shape to the retardance varies by nanopore volume and the ratio between W and H. The overall total retardance depends also on the density of the nanopores and the length of the region or volume containing the nanopores. The total energy can be modified by changing parameters including the pulse duration, individual pulse energy, pulse repetition rate, number of pulses and numerical aperture of the pulse focusing. Hence, both the retardance and the slow axis orientation of the birefringence provided by a nanostructure can be readily controlled, and profiles of birefringence variation as described herein can be readily created.

For both type II structures and type X structures, it is typical to apply a multiplicity of ultrashort laser pulses to the substrate material, in order to create a consistent and uniform birefringence. For example, about 10 or 50 or 100 pulses or more might be used. The laser light of the writing beam is polarised, where a defined polarisation direction is required in order to shape the nanopores into an oblate spheroidal shape to achieve the anisotropy that produces the desired birefringence. The polarised writing light has an anisotropic electric field distribution which is enhanced at the equators of the initially spherical nanopores induced in the substrate material by the laser pulses and causes the spheres to grow into oblate shapes with a longer dimension oriented perpendicular to the polarisation direction of the laser light. Accordingly, writing nanopores of a particular birefringence into a substrate can be achieved using ultrashort laser pulses with a polarisation direction or orientation which is selected to define the slow axis orientation of the birefringence, and an amount of optical energy which is selected to define the level of retardance of the birefringence.

Nanostructure writing can be carried out using linearly polarised light to define the birefringence slow axis orientation. In order to provide a full range of orientations, the polarisation orientation needs to be variable between 0° to 180°, which is set using a variable retardance polarising element to produce the linear polarisation state, such as an electro-optic modulator. Alternatively, elliptically polarised light can be used to write nanostructures into substrate materials, it having been found that the orientation of an elliptical polarisation acts in the same way as the orientation of linear polarisation to define the slow axis orientation of the birefringent nanostructure. Hence, elliptically polarised light can straightforwardly replace linearly polarised light. Additionally, the retardance of the birefringent nanostructure also depends on the ellipticity of elliptically polarised light, so this property can be used to control the retardance when writing the nanostructure. This arrangement can avoid the need to adjust the amount of optical power in order to achieve a particular retardance. A constant pulse power (and writing speed, and pulse repetition rate, and other factors that determine the total amount of power delivered) can be used throughout the fabrication of a complete variable birefringence profile, and only the polarisation characteristics need be varied.

Additional information regarding birefringent nanostructures and methods of writing them into a substrate can be found in WO 2019/158910 [3], WO 2020/109767 [4] and WO 2020/109768 [5].

An attractive feature of replacing Wollaston and Nomarski prisms with birefringent optical elements described herein is the avoidance of costly optically birefringent crystal materials such as quartz and calcite which are used to make such prisms. The bulk material of the substrate used to form the optical element is a transparent material (having a significant transmission for at least some wavelengths across the spectrum from ultraviolet to the near-infrared (roughly 200 nm to 2500 nm) having a high transparency at the wavelength of the writing laser pulses, and also at the wavelength of the illumination beam in the microscope for which it is intended). Usefully, the material may be an amorphous glass material. For example, it may be silica (silicon dioxide, SiO₂), including fused silica. The silica or other glass material might be doped with other materials to modify its optical properties (which may be interest for particular applications). Examples of doped or multicomponent glasses may include materials such as Al₂O₃, B₂O₃, alkaline earth oxides and Na₂/K₂O but other elements and compounds may be used; the disclosure is not limited in this regard. Other materials for the optical element may be any material able to support the laser induced nanostructures, including materials in which nanogratings such as a type II modification or a type X modification have previously been demonstrated. These include multicomponent glasses, GeO₂ glass, porous glass, aerogel glass, silicon and silicon materials, semiconductor materials, lithium niobate and other lithium oxide compounds. Other materials are not excluded, however. The nanostructures are formed so as to be embedded within the volume of the substrate material of the optical element. They can be formed in a single layer, with a thickness of the layer in a range of about 50 μm to about 500 μm providing a suitable birefringent effect, although other layer thicknesses are not excluded.

The time taken to write the birefringent nanostructure into the substrate is proportional to the amount of retardance which is produced. As an example, the average retardance of a 10 mm by 10 mm square birefringent field in an optical element according to the first example might be 37.5 nm, whereas an optical element according to the second example might have a retardance of 280 nm. Hence, the writing time for a first example optical element can be at least five times less than for a second example optical element, so in some cases might be a preferred configuration. However, where a larger birefringent field size or a larger average retardance is required, a second example optical element may be preferred. DIC microscopy with a high resolution in the final image requires a small shear distance, for which a first example optical element will typically be a better choice. On the other hand, DIC microscopy with a high contrast in the final image requires a large shear distance, and therefore a second example optical element may be a better choice here.

The birefringent optical elements described herein simulate the operation of beam-shearing prisms such as Wollaston prisms, Nomarski prisms and Fresnel triprisms. Consequently, their application is not limited to use in DIC microscopes, and they may additionally be used to replace conventional beam-shearing prisms in other optical apparatus. Examples include a digital holographic interferometer [6] and shearing interferometers [7]. Also, they may be used to produce a high precision zero order Soleil-Babinet compensator. The optical elements described are effectively zero order birefringent wedges which can be oriented in opposite directions and used in place of quartz wedges in a Soleil-Babinet compensator with any need for an additional compensation birefringent plate. This modification can provide improved precision and a much wider angle field of view.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

### REFERENCES

[1] U.S. Pat. No. 7,233,434
[2] U.S. Pat. No. 7,564,618
[3] WO 2019/158910
[4] WO 2020/109767
[5] WO 2020/109768
[6] J-M Desse and F Olchewsky, “Use of Wollaston prism for dual-reference digital holographic interferometry”, https://doi.org/10.1364/DH.2019.Tu4B.4
[7] RD Small, VA Sernas and RH Page, “Single Beam Schlieren Interferometer using a Wollaston prism”, https://doi.org/10.1364/AO.11.000858

1. A birefringent optical element for transforming an incident beam of light into two spatially separated output beams of light with orthogonal linear polarizations, comprising:
a transparent substrate with an input face for receiving the incident beam, an output face, and a uniform thickness between the input face and the output face, the substrate having a non-uniform birefringence in a plane parallel to the input face, the birefringence provided by a plurality of randomly positioned nanostructures within the substrate and configured to cause the incident beam to shear within the substrate into two output beams with orthogonal linear polarisations and wavefronts at an angle to one another so that the output beams leave the output face with a spatial separation along a shear direction parallel to the output face;
wherein each nanostructure has an oblate spheroidal shape with an elliptical cross-section in a plane parallel to the input face, the orientation of the elliptical cross-section giving a slow axis orientation of birefringence and a size of the oblate spheroidal shape giving a retardance value of birefringence, the orientation and the size varying between the nanostructures to provide the non-uniform birefringence of the substrate.

2. A birefringent optical element according to claim 1, wherein the non-uniform birefringence has a birefringence profile across the substrate in which the birefringence varies along a first direction which is parallel to the shear direction and is constant along a second direction which is orthogonal to the shear direction.

3. A birefringent optical element according to claim 2, wherein the birefringence profile along the first direction has a varying retardance value and a non-varying slow axis orientation.

4. A birefringent optical element according to claim 3, wherein the retardance value has a constant gradient along the first direction between opposite edges of the birefringence profile.

5. A birefringent optical element according to claim 4, wherein along the first direction, the retardance value is zero at a centre of the birefringence profile, increases to a maximum positive value at one edge of the birefringence profile, and decreases to a maximum negative value at an opposite edge of the birefringence profile.

6. A birefringent optical element according to claim 3, wherein the birefringence profile along the first direction has a first slow axis orientation between a first edge of the birefringence profile and a centre of the birefringence profile, and a second slow axis orientation which is orthogonal to the first slow axis orientation between the centre and a second edge of the birefringence profile opposite to the first edge.

7. A birefringent optical element according to claim 6, wherein one of the first slow axis orientation and the second slow axis orientation is parallel to the first direction and the other of the first slow axis orientation and the second slow axis orientation is parallel to the second direction.

8. A birefringent optical element according to claim 7, wherein the retardance value is positive where the slow axis orientation is parallel to the first direction and the retardance value is negative where the slow axis orientation is parallel to the second direction.

9. A birefringent optical element according to claim 3, wherein, along the first direction, the birefringence profile has a retardance value Δ defined by Δ=α·x−αX/2 and a slow axis orientation φ defined by φ=90°, x<X/2; φ=0°, x>X/2, where x indicates position along the first direction between 0 and X, X is a size of the birefringence profile along the first direction, and a is a derivative of retardance A with respect to x.

10. A birefringent optical element according to claim 2, wherein the birefringence profile along the first direction has a non-varying retardance value and a varying slow axis orientation.

11. A birefringent optical element according to claim 10, wherein the slow axis orientation has a constant gradient along the first direction between opposite edges of the birefringence profile.

12. A birefringent optical element according to claim 10, wherein the slow axis orientation is parallel to the second direction at a first edge of the birefringence profile, and rotates at a constant rate towards or to an orientation parallel to the first direction at a second, opposite edge of the birefringence profile.

13. A birefringent optical element according to claim 10, wherein the non-varying retardance value is half the value of an intended wavelength of the incident beam.

14. A birefringent optical element according to claim 10, wherein, along the first direction, the birefringence profile has a retardance value A defined by Δ=λ/2 and a slow axis orientation φ defined by φ=β·x, where λ is an intended wavelength of the incident beam, x indicates position along the first direction, and β is the gradient magnitude of rotation of the slow axis orientation.

15. A birefringent optical element according to claim 2, wherein the birefringence profile has a square shape such that its size along the first direction is equal to its size along the second direction.

16. A birefringent optical element according to any preceding claim 1, wherein the substrate comprises silica glass.

17. An optical assembly for transforming an incident beam of light into two spatially separated output beams of light with orthogonal linear polarizations, comprising:
a first birefringent optical element according to claim 1;
a second birefringent optical element according to claim 1; and
an optical rotator sandwiched between the first birefringent optical element and the second birefringent optical element.

18. An optical assembly according to claim 17, wherein the optical rotator is configured to provide 90° of rotation, and the first birefringent optical element and the second birefringent optical element are arranged with their optical axes orthogonal to one another.

19. A differential interference contrast microscope comprising one or both of:
a birefringent optical element according to claim 1, and arranged to shear an illuminating beam of light in the microscope into two spatially separated beams of light with orthogonal linear polarizations for illuminating a specimen placed in the microscope; and
a birefringent optical element according to claim 1, and arranged to receive two spatially separated beams of light with orthogonal linear polarizations from the specimen by transmission or reflection, and converge the two spatially separated beams of light into a single output beam of light for observation or detection.

20. An orientation-independent differential interference contrast microscope comprising one or both of:
an optical assembly according to claim 17, and arranged to shear an illuminating beam of light in the microscope into two spatially separated beams of light with orthogonal linear polarizations for illuminating a specimen placed in the microscope; and
an optical assembly according to claim 17, and arranged to receive two spatially separated beams of light with orthogonal linear polarizations from the specimen by transmission or reflection, and converge the two spatially separated beams of light into a single output beam of light for observation or detection.
